(19) United States
(12) Patent Application Publication
(10) Pub. No.: US 2011/0184815 A1
(43) Pub. Date: Jul. 28, 2011

(54) SYSTEM AND METHOD FOR SHARING PROFITS WITH ONE OR MORE CONTENT PROVIDERS

(76) Inventor: Seok Won Song, Seoul (KR)

(21) Appl. No.: 13/059,271

(22) PCT Filed: Aug. 17, 2009
(86) PCT No.: PCT/KR09/04592

§ 371 Date: Mar. 30, 2011

(30) Foreign Application Priority Data
Aug. 18, 2008 (KR) 10-2008-0080547

(51) Int. Cl. G06Q 30/00

(52) U.S. Cl. 705/14.69; 705/30

(57) ABSTRACT

Disclosed herein is a system and method for sharing profits with one or more content providers. The system includes an operation server unit, at least one user terminal connected to the operation server unit over a communication network, and at least one content server. The operation server unit includes a web site storage unit for storing web page data, a content provider recognition unit for receiving content from the content server and recognizing the content server and a content provider, and a profit sharing unit for outputting the content through a web page composed of web page data stored in the web site storage unit, and sending and outputting the content to the user terminal, and analyzing information about the selection of content in the web page and sharing profits produced by the web page with the content server or content provider.

### TECHNICAL FIELD

The present invention generally relates to a system and method for sharing profits with one or more content providers in a system for providing content over a communication network such as the Internet. More specifically, the present invention relates to a system and method for, when a user selects content information from a web page providing content information and advertising content, calculating profit sharing rates based on data about the selection of the content information, and sharing profits produced by the web page with one or more content servers or content providers providing the content information based on the calculated profit sharing rates.

### BACKGROUND ART

Searching for information, using information and providing information through web sites are being widely performed. As concerns providing information, a web site such as a portal website is commonly operated as part of a structure including one or more content providers adapted to provide knowledge, opinions and inquiries-related content to the web site, one or more content users adapted to search and use the content of the web site using the search means of the web site, and search terms-related advertising content configured to be output, along with retrieved content, through a search result page when the content users search for the content to be retrieved.

In the structure related to the web site, there are benefits in that the operator of the web site can produce advertising profits and the content user can use desired content information free of charge. In contrast, the content providers who play an important role in the operation of the web site do not receive any profits related to the operation of the web site.

Korean Patent No. 10-0843775 (entitled “Knowledge-search Service Management Method combined with Knowledge Category-based Advertising Profit Sharing Model), which was applied for and registered by the present applicant, discloses an invention that was devised to overcome the problem of the conventional web site, that is, to provide benefits to content providers by sharing the advertising profits of a web site with the content providers.

The invention disclosed in the patent includes the steps of: (a) assigning sub-domains to respective knowledge categories and storing them; (b) receiving various types of knowledge information sources (a personal web site, a knowledge blog, the knowledge information of a knowledge blog, and a message of a knowledge message board) from netizens and storing the input knowledge information sources while designating respective knowledge categories, determined by the netizens or determined previously, for the knowledge information sources; (c) when there is a request for searching the stored knowledge information sources for a specific search term, outputting a list of knowledge information sources related to the search term in the form of a search result page in which the knowledge information sources have been classified into knowledge categories; (d) when access is made to a specific knowledge information source in the search result page, preparing and storing a knowledge information access history including the identification information of a knowledge category to which the accessed information source belongs, the identification information of the knowledge information source, the identification information of the provider of the knowledge information source, and an access date; (e) determining all advertising revenues obtained from advertising performed in the knowledge categories assigned to the sub-domains for a specific period of time, or a predetermined amount of money calculated according to a predetermined rate to be the shares of the netizens; (f) calculating the number of accesses to each of the knowledge information sources and the total number of accesses, that is, the sum of the numbers of accesses to the knowledge information sources, for the period of time with reference to stored access histories, and calculating the ratio of the number of accesses to each of the knowledge information sources to the total number of accesses, wherein the total number of accesses is calculated by summing the numbers of accesses to respective types of knowledge information sources (a personal web site, a knowledge blog, the knowledge of a information knowledge blog, and a message of a knowledge message board); and (g) proportionally dividing the shares, determined at step (e), based on predetermined rates according to the type of knowledge information source, proportionally dividing the resulting divided shares proportionally, divided according to the type of knowledge information source, into amounts based on the relative numbers of accesses of respective knowledge information sources calculated at step (f), and depositing the resulting amounts for the providers or owners of the knowledge information sources.

The invention disclosed in the above patent has the limitation of sharing profits only to content providers who previously input knowledge information sources because the invention is configured to assign sub-domains to respective knowledge categories, store them, receive knowledge information sources, such as a personal web site, a knowledge blog, the knowledge information of a knowledge blog and a message of a knowledge message board, from netizens, allow netizens to designate knowledge categories to which the input knowledge information sources belong or designate predetermined knowledge categories for the input knowledge information sources, store them, and enable users to search and view the stored knowledge information. Accordingly, there is the demand for means for sharing profits with anonymous content providers who create a large amount of and various types of open content over the web.

### DISCLOSURE OF INVENTION

### Technical Problem

Accordingly, the present invention has been made keeping in mind the above problems occurring in the prior art, and an object of the present invention is to provide a system and method for sharing profits with one or more content servers or content providers, which output received content through an information provision web page or a Wireless Application Protocol (WAP) page (hereinafter referred to as the “information provision web page”) provided with search means or means for retrieving content from an external server and web site and, when there are one or more input signals for selecting the output content, share profits, produced by the web page, with one or more content servers or content providers providing the content.

Another object of the present invention is to provide a system and method for sharing profits with one or more content servers or content providers, which classify content, output through the information provision web page and retrieved from an external content server, into directories according to the features of the content, generate directory identification codes for the content and assign the directory identification codes to the content, so that the content classified into directories can be provided in the information provision web page, thereby enabling users to use the content more efficiently.

### Solution to Problem

In order to accomplish the above objects, the present invention provides a system for sharing profits with one or more content providers, comprising an operation server unit, at least one user terminal connected to the operation server unit over a communication network, and at least one content server, wherein the operation server unit includes a web site storage unit for storing web page data to be output to the user terminal; a content provider recognition unit for receiving content from the content server and recognizing the content server and a content provider; and a profit sharing unit for outputting the content provided by the content server through a web page composed of web page data stored in the web site storage unit, and sending and outputting the content to the user terminal, and analyzing information about selection of content in the web page which is input from the user terminal and sharing profits produced by the web page with the content server or content provider.

In addition, the present invention provides a method of providing information using a system for sharing profits with one or more content providers, including an operation server unit, at least one user terminal connected to the operation server unit over a communication network, and at least one content server, the method including the steps of the user terminal requesting a web page from the operation server; the operation server receiving input signals used to select content, displayed in the web page and provided by the content server, from the web page output to the user terminal; calculating profit sharing rates by analyzing the content selection input signals input by the user terminal; and sharing the profits with the content server or content provider based on the profit sharing rates calculated as described above and profits made in the web page.

### Advantageous Effects of Invention

According to the present invention, users can use accurate information because the profit sharing system of an information provision web site classifies various types of open content over the web into directories, and both users and content providers can benefit because profits can be shared with the content providers who provide content over the web.

### BRIEF DESCRIPTION OF DRAWINGS

The above and other objects, features and advantages of the present invention will be more clearly understood from the following detailed description taken in conjunction with the accompanying drawings, in which:

FIG. 1 is a diagram showing the schematic construction of a system for sharing profits with content providers according to an embodiment of the present invention;

FIG. 2 is a flowchart illustrating a method of sharing profits with content providers according to an embodiment of the present invention;

FIG. 3 is a flowchart illustrating a method of sharing profits with content providers according to another embodiment of the present invention; and

FIG. 4 is a flowchart illustrating a method of sharing profits with content providers according to still another embodiment of the present invention.

### MODE FOR THE INVENTION

The construction of the embodiments of the present invention will be described in detail below with reference to the accompanying drawings.

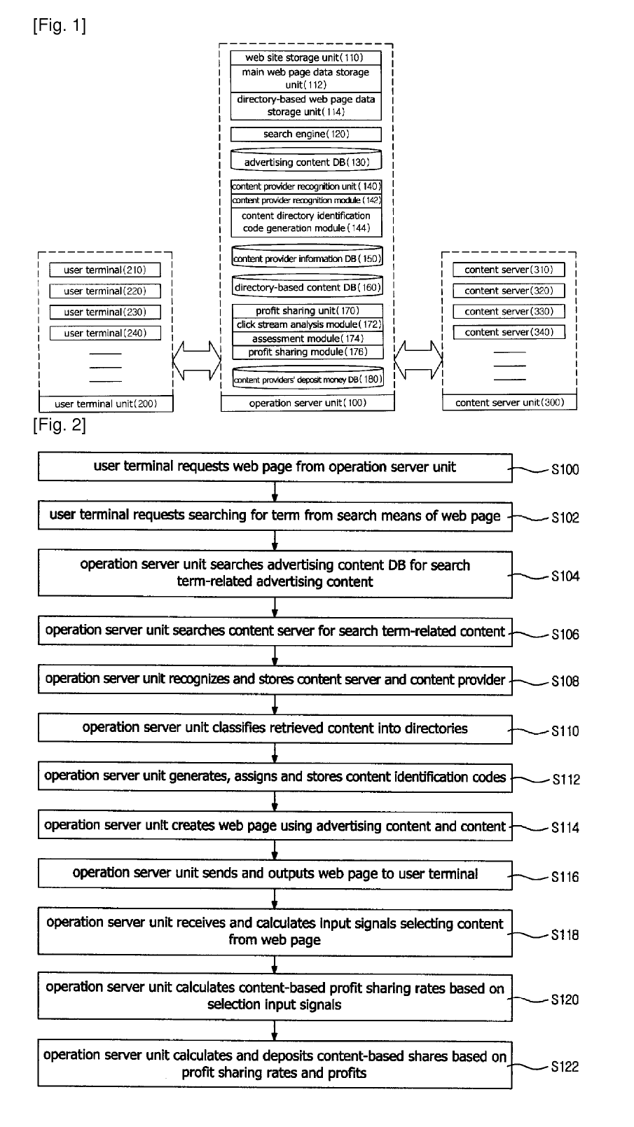

FIG. 1 is a diagram showing the schematic construction of a system for sharing profits with content providers according to an embodiment of the present invention. As shown in FIG. 1, the system for sharing profits with one or more content providers according to the present invention includes an operation server unit 100, a user terminal unit 200 including a plurality of user terminals 210˜240 connected to the operation server unit 100 over a communication network, and a content server unit 300 including a plurality of content servers 310˜340.

The operation server unit 100 of the present invention includes a web site storage unit 110 including a main web page data storage module 112 for storing data used to constitute a main web page and a directory-based web page data storage module 114 for storing data used to constitute web pages for respective directories; a search unit 120 for searching advertising content and information content; an advertising content database (DB) 130 for storing advertising content to be output onto the web pages; a content provider recognition unit 140 including a content provider recognition module 142 for recognizing the content servers and content providers which provide content for the web pages and a content directory identification code generation module 144 for classifying the content provided by the content servers for respective categories according to the features of the content, and generating and assigning directory identification codes for and to respective pieces of content; a content provider information DB 150 for storing information about the content providers recognized by the content provider recognition module 142; a profit sharing unit 170 including a directory-based content DB 160 for storing the content assigned the directory identification codes generated by the content directory identification code generation module 144 for respective directories, a click stream analysis module 172 for, when input signals for selecting content displayed on web pages output to the user terminals of the user terminal unit 200 are generated, collecting and analyzing click information about content for which the selection input signal have been generated, an assessment module 174 for calculating profit sharing rates for respective pieces of content based on the click stream information analyzed by the click stream analysis module 172, and a profit sharing module 176 for sharing profits for respective pieces of content based on the profit sharing rates calculated by the assessment module 174 and profits made through the web page; and a content providers' deposit money DB 180 for accumulating content-based profits calculated by the profit sharing unit 170.

The content server 310˜340 included in the content server unit 300 has a concept covering, for example, servers for providing portal websites over the Internet, servers for providing personal blogs, and servers for hosting personal web sites. Furthermore, the content servers 310˜340 are servers which operate external web sites which do not perform membership, URL and content registration in the operation server unit 100.

In the embodiment of the present invention, the user terminals 210˜240 of the user terminal unit 200 connect to the operation server unit 100 over a communication network, and request web pages. The operation server unit 100 receives web page request signals from the user terminal unit 200, and sends and outputs the web pages from the web site storage unit 110 to the user terminal unit 200. The user terminals 210˜240 of the user terminal unit 200 request the operation server unit 100 to search for desired search terms by entering the search terms using search means provided in the output web pages. The operation server unit 100 receives the requests for searching for the search terms, searches the advertising content DB 130 for search terms-related advertising content and the content servers 310˜340 for search terms-related information content using a search engine 120. The content provider recognition module 142 of the content provider recognition unit 140 of the operation server unit 100 recognizes content server information and content provider information in the content received from the content servers 310˜340, and stores the content server information and the content provider information in the content provider information DB 150. The content directory identification code generation unit 144 classifies the received content into respective directories suitable for the features of the content through the search term analysis and search term and related term analysis of the received content, generates content identification codes corresponding to respective directories, assigns the content identification codes to the content, stores the content classified into respective directories in the directory-based content DB 160 and, at the same time, sends the content classified into respective directories and advertising content to the user terminals 210˜240, thereby outputting them through the web pages.

When input signals selecting content are generated by the user terminals 210˜240 to which the web pages for displaying the content provided by the content servers were output, the operation server unit 100 receives these signals, and the click stream analysis module 172 of the profit sharing unit 170 collects and analyzes the content-based click information. The assessment module 174 calculates content-based profit sharing rates according to predetermined criteria based on content-based click stream information analyzed by the click stream analysis module 172. The profit sharing module 176 calculates content-based profits based on the content-based on the profit sharing rates calculated by the assessment module 174 and profits produced by the web pages, and deposits profits for the content in the content providers' deposit money DB 180 in the form of the content provider information.

The content provider recognition module 142 may recognize, for example, the highest-level domain information (for example, AAA.com) in the URL information of the received content, recognize information about persons registering the content in the highest domain that is included in the URL information (for example, AAA.com/id, AAA.com/id1, and AAA.com/id2), and then store them in the content provider information DB 150. Alternatively, in the above example, the content provider recognition module 142 may recognize the highest domain information (for example, AAA.com) in the URL information of the received content and then store it in the content provider information DB 150, and may recognize information about persons registering the content in the highest domain that is included in the URL information (for example, AAA.com/id, AAA.com/id1, and AAA.com/id2) and then store it in the content provider information DB 150 using the stored highest domain information (AAA.com) as a group key so that it can belong to the group key.

In this case, each of id, id1 and id2 includes the domain or the distinct code of a corresponding content provider (for example, AAA.com/John.com, AAA.com/John1.com, or AAA.com/John2.com). Alternatively, in the above example, the content provider recognition module 142 may recognize lower domain information (for example, aaa.AAA.com) and information about persons registering the content in the lower domain (for example, aaa.AAA.com/id, aaa.AAA.com/id1, and aaa.AAA.com/id2) that is included in the URL information, and then store them in the content provider information DB 150. In this case, each of id, id1 and id2 includes the domain or the distinct code of a corresponding content provider (for example, aaa.AAA.com/John.com, aaa.AAA.com/John1.com, or aaa.AAA.com/John2.com). Alternatively, in the above example, the content provider recognition module 142 may recognize lower domain information (for example, aaa.AAA.com) in the URL information of the received content and then store it in the content provider information DB 150, and may recognize information about persons registering the content in the lower domain that is included in the URL information (for example, aaa.AAA.com/id, aaa.AAA.com/id1, and aaa.AAA.com/id2) and then store it in the content provider information DB 150 using the stored lower domain information (aaa.AAA.com) as a group key so that it can belong to the group key. In this case, each of id, id1 and id2 includes the domain or the distinct code of a corresponding content provider (for example, AAA.com/John.com, AAA.com/John1.com, or AAA.com/John2.com).

By using the content provider recognition method exemplified in conjunction with the content provider recognition module 142, when profits are shared by the profit sharing module 176, the profits may be shared and deposited for the highest domain information (AAA.com), lower domain information (aaa.AAA.com) and respective pieces of content Provider information (AAA.com/id, AAA.com/id1, AAA.com/id2; aaa.AAA.com/id, aaa.AAA.com/id1, and aaa.AAA.com/id2) of the content servers. Alternatively, all of the profits to be shared with all the content providers belonging to the highest domain information (AAA.com) or lower domain (aaa.AAA.com) may be deposited for the group key, that is, the highest domain information (AAA.com) or lower domain information (aaa.AAA.com). This may be performed based on various hierarchical systems capable of identifying content providers, such as the domain system or the Internet Protocol address system.

The content directory identification code generation module 144 receives content retrieved from the content servers 310˜340 in response to search requests, and classifies the received content into directories suitable for the content through the search term analysis and search term and related term analysis of the received content. Identification codes are generated and assigned to the corresponding content based on respective directories. For example, in the case where a search term is “patent” and three pieces of content have been retrieved from AAA.com, when a passage of a first piece of content (for example, AAA.com/id1) is “won using a new patented tennis racket”, a passage of a second piece of content (for example, AAA.com/id2) is “a Korean company won a U.S. patent law suit” and a passage of a third piece of content (for example, AAA.com/id3) is “government-funded laboratory's success in the development of a new technology fire-retardant process, which is desired to be protected under a patent,” the content directory identification code generation module 144 classifies the first piece of content (AAA.com/id1) in the “sports” directory and then the identification code “sports” is generated, classifies the second piece of content (AAA.com/id2) in the “law” directory and then the identification code “law” is generated, and the third piece of content (AAA.com/id3) in “science technology” directory and then identification code “science” is generated, so that “AAA.com/sports/id1”, “AAA.com/law/id1” and “AAA.com/science/id1” are assigned to the respective pieces of content.

As in the above example, classification into directories may be performed by the content directory identification code generation module 144, respective pieces of content assigned identification codes related to the directories may be stored in the directory-based content DB 160, and the content may be grouped and displayed based on the above directories in search result pages output into the user terminals 210˜240. In this case, in preparation for the storage of a large amount of directory-based content, a directory-based content server may be provided in addition to the directory-based content DB 160 and be used to store content.

The web site storage unit 110 of the present invention may include main web pages composed of data stored in the main web page data storage unit 112 for providing search results in response to search requests from the user terminals 210˜240 and directory-based sub-web pages composed of data used to show larger amounts of content related to the content output through the main web pages and stored in the directory-based web page data storage unit 114. In this case, part of retrieved content is grouped and output based on directories through a main web page. If a user wants to use a larger amount of information related to the content of a selected directory, a subweb page for the selected directory may be output. It will be apparent that advertising content may be displayed in sub-web pages and profits produced thanks to the advertising content may be shared with the content servers 310˜340 or content providers which provide the content selected by the user terminals. In another embodiment in which main web pages and directory-based sub-web pages are provided, a registered content DB for storing its own content information registered in the operation server unit 100 is provided, content retrieved from the registered content DB is output through a main web page as search results, and the content retrieved by the content servers 310˜340 and classified based on directories is output through directory-based sub-web pages. In this case, profits for the content output through the main web page may be shared in such a way that the profits produced by the main web page are deposited according to the profit sharing rates, while profits for the content output through the directory-based sub-web pages may be deposited in such a way that profits produced by respective sub-web pages are deposited according to the profit sharing rates.

A method of calculating profit sharing rates using the assessment module 174 of the profit sharing unit 170 may include a first method of analyzing click streams for respective pieces of content selected from a web page and then calculating profit sharing rates based on analysis results, as described above, and a second method of calculating profit sharing rates through the combination of the level of contribution of a web site which provides content selected from a web page, for example, the level of contribution of the web site obtained through the analysis of the relative level of contribution of the web site to other web sites, such as the overall level of popularity of the web site and the level of preference and the number of clicks related to a specific search term, and the first method.

The first method will now be described in more detail. The first method may be classified into two cases: the case where content is used in a main web page and the case where content is used in a directory-based sub-web page. In the case where content is used in a main web page, profits produced by the main web page are shared by analyzing click streams for respective pieces of content for a predetermined period of time. In contrast, in the case where content is used in a directory-based sub-web page, profits produced by a sub-web page related to a corresponding directory are shared by analyzing click streams for respective pieces of content for a predetermined period of time.

As a more specific example, if all profits produced by a main web page or the subweb page of a specific directory thereof for a predetermined period of time are Y, the total number of clicks for all pieces of content output through the main web page or the sub-web page of the specific directory for the predetermined period of time is N and the number of clicks for specific content A is X, a profit sharing rate for the content A is calculated as X/N×100% and a deposited profit share is calculated as (X/N×100%)×Y.

FIG. 2 is a flowchart illustrating a method of sharing profits with one or more content providers according to an embodiment of the present invention. As illustrated in FIG. 2, the method of sharing profits with one or more content providers according to the embodiment of the present invention includes a step S100 of each of the user terminals requesting a web page from the operation server unit connected over a communication network, step S102 of the user terminal inputting a search term and requesting searching using web page search means provided in the operation server unit, step S104 of the operation server unit receiving the request for searching and searching the advertising content DB for search term-related advertising content, step S106 of one or more content servers connected to the operation server unit searching for the search term-related content, step S108 of the operation server unit recognizing the content servers or content providers providing the retrieved content and storing recognized information, step S110 of the operation server unit classifying the retrieved content into directories through search term analysis or search term and related term analysis, step S112 of the operation server unit generating, assigning and storing corresponding directories-related identification codes for the classified content, step S114 of the operation server unit creating a search result page used to output the retrieved advertising content and the directory-classified, stored content through a web page, step S116 of the operation server unit sending and outputting the search result page to the user terminal, step S118 of the operation server unit receiving and counting selection input signals related to pieces of content output through the search result page for a predetermined period of time, step S120 of the operation server unit calculating profit sharing rates for respective pieces of content based on information about the counted input signals for respective pieces of content, and step S122 of the operation server unit calculating and depositing profit shares for respective pieces of content based on the profit sharing rates calculated for respective pieces of content and profits produced by the web page for a predetermined period of time.

The above-described method of sharing profits with one or more content providers according to the present invention is merely one of a variety of embodiments. Although in the embodiment, the method has been described as being configured such that each of the user terminals makes a search request and the operation server unit outputs content and related advertising content through a search result page, there may be provided a method implemented such that pieces of content are freely or automatically output using a content collector and content users selectively connect to the pieces of output content. A representative method thereof may be the enumeration of content using the Extensible Markup Language (XML) or Rich Site Summary or Really Simple Syndication (RSS) of content providers, or the provision of the Widgets of content providers as content.

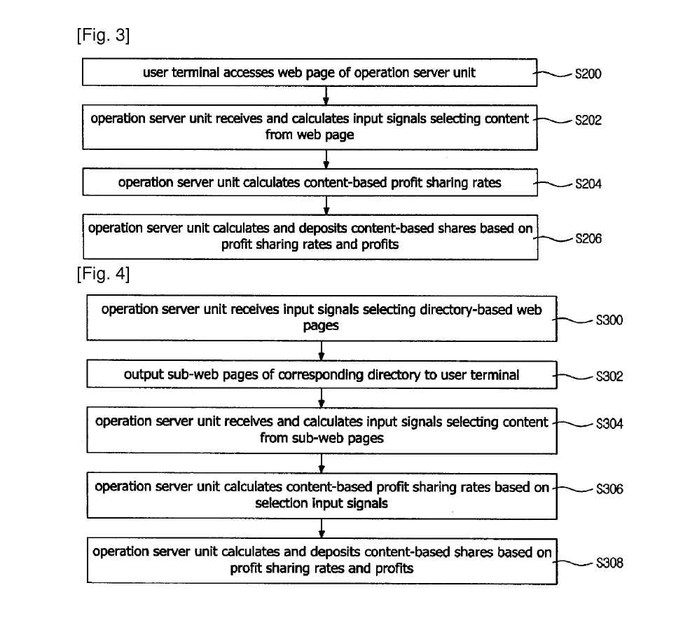

FIG. 3 is a flowchart illustrating a method of sharing profits with one or more content providers according to another embodiment of the present invention. The method of sharing profits with one or more content providers according to another embodiment of the present invention includes step S200 of each of the user terminals connecting to the web page in which predetermined advertising content provided by the operation server unit and at least one piece of content provided by the operation server unit including a content collector or by at least one content server are displayed, step S202 of the operation server unit receiving and counting content selection input signals from the web page for a predetermined period of time, step S204 of the operation server unit calculating profit sharing rates for respective pieces of content based on information about the calculated input signals for respective contents, and steps S206 of calculating and depositing profit shares for respective pieces of content based on the profit sharing rates for respective pieces of content calculated by the operation server unit and profits produced by the web page for a predetermined period of time. In this case where the content of the content providers is displayed almost in real time, there may be no intervention of the content server unit.

Alternatively, a method of sharing profits with one or more content providers according to still another embodiment of the present invention may be implemented such that advertising content output through a search result page is freely selected by the operation server unit and one or more content servers search for the corresponding content and output it through the search result page in response to the request from each of the user terminals.

FIG. 4 is a flowchart illustrating the method of sharing profits with one or more content providers according to still another embodiment of the present invention. The method of sharing profits with one or more content providers according to still another embodiment of the present invention includes step S300 of the operation server unit receiving one or more directory-based sub-web page selection input signals from a search result page output to each of the user terminals, step S302 of the operation server unit sending and outputting a directory-based sub-web page, through which content retrieved from one or more content servers and related to a selected directory is output, to the user terminal, step S304 of the operation server unit receiving and counting selection input signals related to pieces of content output through the directory-based sub-web page for a predetermined period of time, step S306 of the operation server unit calculating profit sharing rates for the pieces of content based on information about the counted selection input signals for respective contents, and step S308 of the operation server unit calculating and depositing profit shares for respective pieces of content based on the profit sharing rates calculated from the respective pieces of content and profits produced by the directory-based sub-web page for the predetermined period of time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-11. (canceled)

12. A system for sharing profits with one or more content providers, comprising an operation server unit, at least one user terminal connected to the operation server unit over a communication network, and at least one content server, wherein the operation server unit comprises:
a web site storage unit for storing web page data to be output to the user terminal;
a content provider recognition unit for receiving content from the content server and recognizing the content server and a content provider; and
a profit sharing unit for outputting the content, provided by the content server, through a web page composed of web page data stored in the web site storage unit, and sending and outputting the content to the user terminal, and analyzing information about selection of content in the web page which is input from the user terminal and sharing profits produced by the web page with the content server or content provider.

13. The system as set forth in claim 12, wherein the content provider recognition unit comprises a content provider recognition module for recognizing information about the content server in which the content to be provided to the operation server has been stored and the content provider using URL information and IP information and a content directory identification code generation module for analyzing the content provided by the content server and then classifying the provided content in a predetermined directory, and generating a directory identification code and then assigning the directory identification code to the content.

14. The system as set forth in claim 12, wherein the profit sharing unit comprises a click stream analysis module for analyzing the input information which is output by the user terminal and is used to select content provided by the content server, an assessment module for calculating profit sharing rates based on data obtained through the analysis of the click stream analysis module, and a profit sharing module for sharing profits with the content server or content provider based on the profit sharing rates calculated by the assessment module and profits produced by the webpage.

15. The system as set forth in claim 12, wherein the profits produced by the web page are profits produced thanks to advertising content output through the web page.

16. The system as set forth in claim 12, wherein the content server is a server that provides a web site having content which a search engine of the operation server can search, or a server that is provided with a web site having content the operation server can retrieve using Rich Site Summary or Really Simple Syndication (RSS) or Widget functionality.

17. A method for sharing profits with one or more content providers using a system including an operation server unit, at least one user terminal connected to the operation server unit over a communication network, and at least one content server, the method comprising the steps of:
the user terminal requesting a web page from the operation server;
the operation server receiving input signals used to select content, displayed in the web page and provided by the content server, from the web page output to the user terminal;
the operation server_calculating profit sharing rates by analyzing the content selection input signals input by the user terminal; and
the operation server sharing the profits with the content server or content provider based on the profit sharing rates calculated as described above and profits made in the web page.

18. A method for sharing profits with one or more content providers using a system including an operation server unit, at least one user terminal connected to the operation server unit over a communication network, and at least one content server, the method comprising the steps of:
the operation server receiving a request for content from the user terminal;
the operation server searching for the content for which the search is requested by the content server using provided search means and outputting search results to the terminal in the form of a web page;
the operation server receiving input signals used to select content, displayed in the web page and provided by the content server, from the web page output to the user terminal;
the operation server calculating profit sharing rates by analyzing the content selection input signals input from the user terminal; and
the operation server sharing profits with the content server or content provider based on the profit sharing rates calculated as described above and the profits produced by the web page.

19. The method as set forth in claim 17, further comprising the step of the operation server recognizing the content server and content provider of the content displayed in the web page of the user terminal.

20. The method as set forth in claim 17, wherein the step of calculating the profit sharing rates comprises the steps of:
collecting click streams to analyze the input information used to select the content output to the user terminal and provided by the content server; and
analyzing the collected click streams and calculating the profit sharing rates based on analysis data.

21. The method as set forth in claim 17, wherein the profits produced by the web page are profits made thanks to advertising content output through the web page.

22. The system as set forth in claim 17, wherein the content server is a server that provides a web site having content which a search engine of the operation server can search and that has no connection with the operation server, or a server that is provided with a web site having content the operation server can retrieve using Rich Site Summary or Really Simple Syndication (RSS) or Widget functionality and that has no connection with the operation server.

23. The method as set forth in claim 18, further comprising the step of the operation server recognizing the content server and content provider of the content displayed in the web page of the user terminal.

24. The method as set forth in claim 18, wherein the step of calculating the profit sharing rates comprises the steps of:
collecting click streams to analyze the input information used to select the content output to the user terminal and provided by the content server; and
analyzing the collected click streams and calculating the profit sharing rates based on analysis data.

25. The method as set forth in claim 18, wherein the profits produced by the web page are profits made thanks to advertising content output through the web page.

26. The system as set forth in claim 18, wherein the content server is a server that provides a web site having content which a search engine of the operation server can search and that has no connection with the operation server, or a server that is provided with a web site having content the operation server can retrieve using Rich Site Summary or Really Simple Syndication (RSS) or Widget functionality and that has no connection with the operation server.
